(19) United States
(12) Patent Application Publication
(10) Pub. No.: US 2008/0243477 A1
(43) Pub. Date: Oct. 2, 2008

(54) MULTI-STAGED LANGUAGE CLASSIFICATION

(75) Inventor: Brian O. Bush, Beaverton, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: RULESPACE LLC, Beaverton, OR (US)

(21) Appl. No.: 12/058,561

(22) Filed: Mar. 28, 2008

Related U.S. Application Data
(60) Provisional application No. 60/909,375, filed on Mar. 30, 2007.

(51) Int. Cl. G06F 17/20

(52) U.S. Cl. 704/8

(57) ABSTRACT

Embodiments of the present invention provide methods and apparatus for determining languages of documents, including text messages and text fragments, generally sent via wireless communication devices. Other embodiments may be described and claimed.

### CROSS REFERENCE TO RELATED APPLICATIONS

The present application claims priority to U.S. Patent Application No. 60/909,375, filed Mar. 30, 2007, entitled “Efficient Multi-Staged Language Classification,” the entire specification of which is hereby incorporated by reference in its entirety for all purposes, except for those sections, if any, that are inconsistent with this specification.

### TECHNICAL FIELD

Embodiments of the present invention relate to the field of data processing, and more particularly, to language classification of text fragments, having particular application in a bandwidth constrained communication environment, e.g. wireless communication.

### BACKGROUND

Wireless communication systems are experiencing an explosive growth in popularity. This increase in popularity has led to a wider utilization of text messaging services whereby text fragments are exchanged between users. Text messages or text fragments may include any type of content ranging from a simple note to a message containing inappropriate content. Furthermore, the inappropriate content may be incorporated directly into the text message itself, or it may be in a more innocuous form, such as a web address where inappropriate content may be found. These text messages, however, often contain very little content, especially when the message is primarily a Uniform Resource Locator (“URL”). In such situations, it is extremely difficult to classify the content of the message. Without such classifications, filtering mechanisms may fail to accurately shield individuals from unwanted or inappropriate material. However, there are many different languages and encodings for documents and thus, recognizing the content of a document may be difficult.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 illustrates an example embodiment of a host device for receiving and classifying text fragments in terms of their languages in accordance with various embodiments of the present invention;

FIG. 2 illustrates a block diagram of an exemplary device capable of receiving and classifying text fragments in terms of their languages, in accordance with various embodiments of the present invention; and

FIG. 3 illustrates a flow diagram view of a portion of the operations of a host device, in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

In various embodiments of the present invention, methods, apparatuses, and systems to facilitate the determination of languages of documents and text fragments are provided. Language classification is vital to accurate generalized document classification. Such a classification, for example, may notify a user that the text fragment contains inappropriate material, or conversely, no inappropriate material. As used herein, the term “document” refers to whole or partial documents, including, but not limited to, text messages and text fragments generally sent via wireless communication devices. The inventive techniques thus may be implemented in any device suitably configured for receiving documents including but not limited to: cellular devices, smart phones, personal digital assistants (“PDAs”), personal computers, and other networked devices. The invention is not to be limited in this regard.

Unicode is a uniform standard that unites text and symbols from virtually all of the writing forms of the world, all possible forms of text and symbols are represented in a common character space. The existence of a specific written form may imply the actual document language. For example, Hiragana characters have a single region in Unicode (0×3042−0×3096) and documents that contain large amounts of Hiragana are most likely Japanese. Similarly, Hangul will most likely be found in Korean documents and so on. Thus, the languages that are amenable to this approach include: Russian; Japanese; Korean; Chinese; Hebrew; Greek; Arabic; and Thai. If a document contains a significant percentage of a specific script, one may conclude that the document language is that of the language that employs the specific script. If there are multiple languages that are active, then, in accordance with various embodiments of the present invention, the language with the highest percentage of “activity” is considered. If no unique languages are discovered, in accordance with various embodiments, the document is considered to be in a Latin-based language (English, French, Spanish, etc).

In accordance with various embodiments of the present invention, a unigram is an individual word or number—a token, and bigrams are pairs of consequent tokens. For example, the sentence “The quick red fox jumped over the white fence” has the following unigrams: (the),(quick), (red), (fox), (jumped), (over), (the), (white), (fence) and the following bigrams: (the quick), (quick red), (red fox), (fox jumped), (jumped over), (over the), (the white), (white fence). A feature is generally a token of importance. A category model is a collection of unigrams and/or bigrams that compose a feature set in combination with a classifier in the form of a predictive model that attempts to describe (or bin) a document based on a set of attributes, which, in accordance with various embodiments of the present invention, are tokens. The feature set will generally contain category-specific unigrams and bigrams, as well as general non-category unigrams and bigrams, e.g., a gambling category model might contain terms related specifically to gambling, as well as general terms not specifically related to gambling.

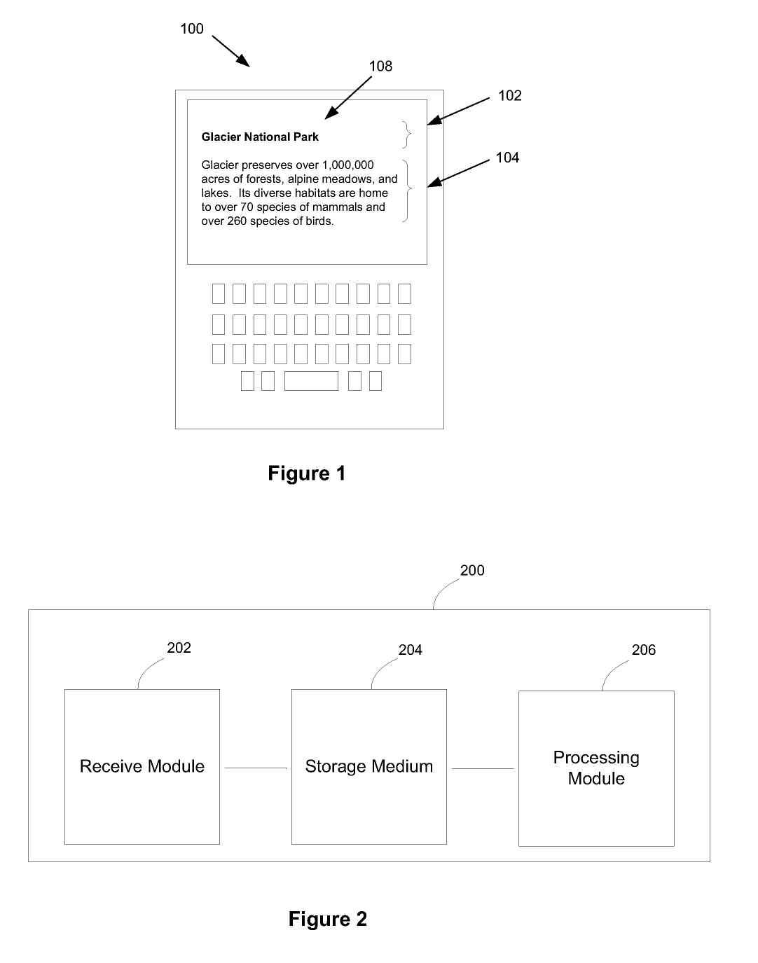

Referring now to FIG. 1, a diagram of an exemplary host device capable of performing language classification, in accordance with various embodiments of the present invention, is illustrated. FIG. 1 includes a host device 100 and a text fragment 108 (shown rendered on a display of host device 100). In the illustrated embodiment, the host device 100 may be any device suitably configured for receiving documents, wirelessly or via a wired line, including text fragment 108. In particular, host device 100 may be dimensioned and configured for portable or mobile usage, such as a mobile phone, a personal digital assistant and so forth. The text fragment 108, in the illustrated embodiment, is a document having a layout structure that includes a title 102 and a body of text 104. As will be readily apparent from the description to follow, text fragment 108, as illustrated in FIG. 1, is merely an example and may also be organized in other manners.

In accordance with various embodiments, the received text fragment or document is generally transcoded by host device 100 into a unified representation. The goal is that all, or nearly all, detectable ways to encode the same content are merged into a single representation by a transcoder. Unicode is an example of a uniform standard that unites text and symbols from virtually all of the writing forms of the world into a unified representation such that many or all possible forms of text and symbols are represented in a common character space. Examples of Unicode include UTF-8 and UTF-16. Thus, in accordance with various embodiments of the present invention, host device 100 may be provided with logic to transcode a received text fragment or document into a unified representation.

In accordance with various embodiments of the present invention, host device 100 is provided with logic to determine a language of a received text fragment or document. In various embodiments, the language determination logic, when encountering a received text fragment or document being made up of a single primary language, considers the single primary language to be the language of the text fragment or document. In various embodiments, the host device 100 is also provided with a classifier in the form of a predictive model that attempts to describe (or bin) a document based on a set of attributes, which, in accordance with various embodiments of the present invention, are tokens. The host device 100 is also provided with category models to evaluate the language determined document and/or to help determine the language of the received text fragment or document, as discussed more fully herein. In various embodiments, the document is evaluated by evaluating the category models corresponding to the determined language or languages.

As mentioned previously, a document's primary language may be determined by determining that the document is entirely or almost entirely in a single language, in accordance with various embodiments of the present invention. Thus, the existence of a specific written form may imply the actual document language. For example, Hiragana characters generally have a single region in Unicode (0×3042−0×3096) and documents that contain large amounts of Hiragana are most likely Japanese. Similarly, Hangul will most likely be found in Korean documents.

Additionally, a document's original encoding, e.g. derived from headers in transmission packets employed to transmit the original document, such as the HyperText Transfer Protocol (“HTTP”) headers or from metadata associated with the content of the document itself, may be used to determine a primary language for the document, especially if two or more languages are found to be active in the document. Thus, if a document contains a significant percentage of a specific script, it may conclude that the document language is that of the language that employs the specific script. If there are multiple active languages, then the language with the highest percentage may be considered the primary language. For example, a document that is originally encoded in Shift-JIS, but includes Chinese and Hiragana characters, is more than likely a Japanese document.

In accordance with various embodiments, such a process alone is generally sufficient to accurately classify a primary language for documents in at least the following languages: Russian, Japanese, Korean, Chinese, Hebrew, Greek, Arabic and Thai. For the aforementioned languages, this generally avoids any further, potentially costly analysis.

In accordance with various embodiments, once a primary language is discovered, the classifier employs category models for the determined language to evaluate the document. The category models are evaluated by classifying unigrams and/or bigrams of the document as to potential content. Thus, a unigram (blackjack) may be classified as recognized as a feature relating to gambling. If a significant number of features (unigrams and/or bigrams that are tokens of importance) are found, the document may be classified as relating to gambling. What constitutes significance may be application dependant.

In accordance with various embodiments, if there is (1) not a single dominant unique language that may serve as a primary language (i.e., there are many languages present in the document but none are dominant) and (2) there is a high UTF-8 validation error count that exceeds a pre-determined threshold (for example, more than three bytes per thousand bytes) and (3) there are too many active languages, thus exceeding a pre-determined threshold, the document may be flagged as being undeterminable with respect to language. In accordance with various embodiments, if there is no dominant or primary language determined yet and the document is not flagged as being undeterminable with respect to language, the document may be defaulted to a pre-specified primary language. In accordance with various other embodiments, if there is no dominant or primary language determined yet and the document is not flagged as being undeterminable with respect to language, the document may be defaulted to being presumed to be a Latin-based language document.

In the event that the document is deemed to be a Latin-based language document, in accordance with various embodiments of the present invention, the language determination logic employs N-gram character models, similar to the approach outlined by William B. Cavnar and John M. Trenkle, Proceedings of SDAIR-94, 3rd Annual Symposium on Document Analysis and Information Retrieval (1994), which is hereby incorporated in its entirety for all purposes, to suggest the language of a document. The output of such a process is a ranked list of languages, of which the top, for example, two languages may be considered, in accordance with various embodiments of the present invention. In accordance with various embodiments, the top N ranked languages may be considered as valid. In accordance with various embodiments, N is two.

In accordance with various embodiments, category models that are Latin-based may now be evaluated noting a feature count for each category model with respect to the top two ranked languages found via the N-gram character models. For a specific common category model, the classifier ranks the feature counts from the two languages. In accordance with various embodiments, the ranking is based upon a ratio of features found per category model per language to total features found per category model. In accordance with various embodiments, the top ranked language is chosen as the Latin-based language document's primary language.

As noted previously, in accordance with various embodiments, once the Latin-based language document's primary language is discovered, the classifier employs category models for the determined language to evaluate the document. The category models are evaluated by classifying the unigrams and/or bigrams of the document as to potential content. Thus, as previously noted, a unigram (blackjack) may be classified as recognized as a feature relating to gambling. If a significant number of features (unigrams and/or bigrams that are tokens of importance) are found, the document may be classified as relating to gambling. What constitutes significance may be application dependent.

Referring now to FIG. 2, a simplified block diagram of an exemplary arrangement, housed within a host device 200, capable of performing multi-stage language classification, in accordance with various embodiments of the present invention, is illustrated. In one embodiment, a receive module 202 functions to allow host device 200 to receive documents and/or text fragments in either a wireless or a wired configuration. In various embodiments the text fragments may be a document received wirelessly, e.g. a Short Message Service (“SMS”) message, a chat message, a Uniform Resource Locator (“URL”), and/or any other form of wirelessly or wired received text. The receive module 202 may perform one or more of, for example, signal demodulation, filtering, analog to digital conversion, decompression and/or decryption. A storage medium 204 is operatively coupled to the receive module 202 and functions to store a plurality of programming instructions that enable the host to transcode some or all of the documents and text fragments, and to perform multi-stage language classification. The storage medium 204 may also store and hold received text. In the illustrated embodiment, the storage medium 204 is operatively coupled to a processing module 206. In accordance with various embodiments, the processing module 206 may act as a transcoder that transcodes part of or all of the documents and/or text fragments. The processing module 206 may also perform multi-stage language classification and to evaluate category models of the text fragment in order to classify content of the text fragment. Such a classification, in various embodiments, may serve to inform a user of the host device 200 of the presence or absence of inappropriate content. In other embodiments, the classification may simply shield the user from any inappropriate content.

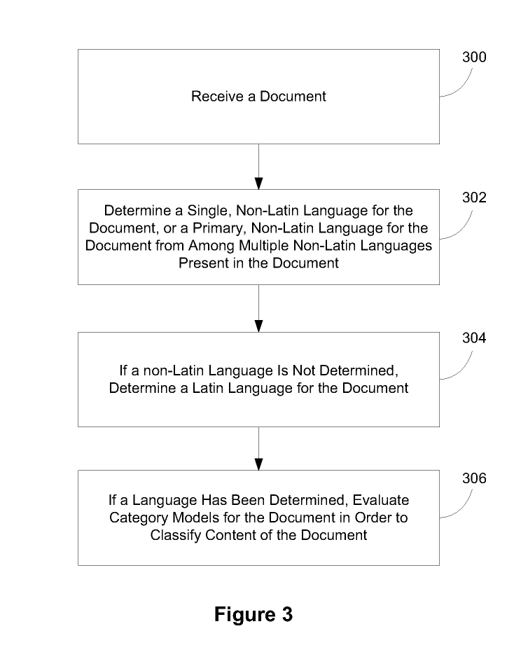

Referring to FIG. 3, a flow diagram view of a portion of the operations of a host device in accordance with various embodiments of the present invention is illustrated. In various embodiments these steps may be performed by any one of a cellular phone, mobile phone, personal digital assistant (“PDA”), and/or any other device capable of sending or receiving documents, text messages or text fragments. In one embodiment, the host device receives a document at block 300. The host device may then, at block 302, determine a single, non-Latin language for the document or a primary, non-Latin language for the document from among multiple, non-Latin languages present in the document. If a non-Latin language is not determined, a Latin language may be determined for the document. At block 306, if a language has been determined for the document, the host device may then evaluate category models for the document in order to classify content of the document.

Thus, it may be seen from the above description, the various embodiments of language determination enable languages of documents to be efficiently determined in a multi-language environment, such as the Internet, and is particularly suitable for multi-language communication in a bandwidth constrained environment, such as wireless communication.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments illustrated and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method comprising:
determining whether a document is a single, non-Latin based language document, including identifying the single non-Latin language; and
evaluating category models corresponding to the single non-Latin language to evaluate the document, if the document is determined to be a single, non-Latin based language document with the single, non-Latin language being identified.

2. The method of claim 1, wherein the method further comprises determining a non-Latin based primary language for the document prior to evaluating category models, if the document is determined to be a multiple, non-Latin based language document.

3. The method of claim 2, wherein determining whether the document is a single, non-Latin based language document comprises evaluating Unicode transcoding of the document, and determining the primary language comprises evaluating the pre-Unicode encoding of the document.

4. The method of claim 2, wherein the method further comprises generating a ranked list of Latin languages if the document is determined or assumed to be a Latin based language document, and the evaluating comprises evaluating category models corresponding to top N Latin languages of the ranked list.

5. The method of claim 4, wherein N is 2.

6. The method of claim 5, wherein the method further comprises calculating a ratio of features found for each of the top 2 Latin languages relative to a total number of features found for the document.

7. The method of claim 6, wherein the features are one of either unigrams and/or bigrams.

8. The method of claim 2, wherein the method further comprises skipping said evaluating if there is no primary language determined, a validation error count exceeds a pre-determined threshold, and/or the number of languages in the document is determined to exceed a pre-determined threshold.

9. The method of claim 2, wherein the method further comprises defaulting to a pre-specified primary language if there is no primary language determined, a validation error count exceeds a pre-determined threshold, and/or the number of languages in the document is determined to exceed a pre-determined threshold.

10. An apparatus comprising:
a receive module configured to receive a text fragment; and
a processing module, operatively coupled to the receive module and configured to determine whether the text fragment is a multi-language text fragment, to determine a primary language of the multiple languages if the text fragment is determined to be a multi-language text fragment, and to evaluate category models corresponding to the primary language to evaluate the multi-language text fragment.

11. The apparatus of claim 10, wherein the processing module is further configured to determine whether the text fragment is a non-Latin, single language text fragment.

12. The apparatus of claim 10, wherein said determining comprises evaluating original encoding of the text fragment.

13. The apparatus of claim 12, wherein the processing module is further configured to generate a ranked list of Latin languages for the multi-language text fragment, and to evaluate category models corresponding to top N Latin languages of the ranked lists.

14. The apparatus of claim 13, wherein N is two.

15. The apparatus of claim 14, wherein the processing module is further configured to calculate a ratio of features found for each of the top two Latin languages relative to a total number of features found for the text fragment.

16. The apparatus of claim 15, wherein the features are one of either unigrams and/or bigrams.

17. The apparatus of claim 11, wherein the processing module is configured to skip said evaluating, if one or more conditions are met, the one or more conditions comprising when there is no single primary language determined, a validation error count exceeds a pre-determined threshold, or the number of languages in the document is determined to exceed a pre-determined threshold.

18. The apparatus of claim 11, wherein the processing module is configured to default to a pre-specified primary language for the text fragment if there is no primary language determined, a validation error count exceeds a pre-determined threshold, and/or the number of languages in the document is determined to exceed a pre-determined threshold.

19. An article of manufacture comprising:
a storage medium; and
a plurality of programming instructions stored on the storage medium and designed to enable a device to:
determine whether a text fragment is a non-Latin language text fragment, if not, determine a primary Latin language for the text fragment, and
evaluate category models of one or more languages to evaluate the text fragment.

20. The article of manufacture of claim 19, wherein determining whether the text fragment is a non-Latin language text fragment comprises evaluating Unicode transcoding of the text fragment, and determining a primary language comprises evaluating original encoding of the text fragment.

21. The article of manufacture of claim 19, wherein determining a primary Latin language for the text fragment comprises generating a list of ranked Latin languages for the text fragment via N-gram character models.

22. The article of manufacture of claim 21, wherein the programming language is configured to evaluate category models of the top N ranked Latin languages to evaluate the text fragment.

23. The article of manufacture of claim 22, wherein N is two.

24. The article of manufacture of claim 23, wherein the programming instructions are configured to calculate a ratio of features found for each of the top two Latin languages relative to a total number of features found for the text fragment.

25. The article of manufacture of claim 24, wherein the features are one of either unigrams and/or bigrams.

26. The article of manufacture of claim 19, wherein the programming instructions are configured to skip the evaluating on one or more conditions, including if there is no single primary language determined, a validation error count exceeds a pre-determined threshold, or the number of languages in the document exceeds a pre-determined threshold.

27. The article of manufacture of claim 19, wherein the programming instructions are configured to default to a pre-specified primary language for the text fragment if there is no primary language determined, a validation error count exceeds a pre-determined threshold, and/or the number of languages in the document is determined to exceed a pre-determined threshold.
